(19) United States
(12) Patent Application Publication
(10) Pub. No.: US 2010/0313913 A1
(43) Pub. Date: Dec. 16, 2010

(54) METHOD FOR CLEANING A HEAT EXCHANGER

(75) Inventors: Ursula Hollwedel, Schnaittach (DE); Franz Ammann, Erlangen (DE)

Correspondence Address: LERNER GREENBERG STEMER LLP, P O BOX 2480, HOLLYWOOD, FL, 33022-2480, US

(73) Assignee: Areva NP GmbH, Erlangen (DE)

(21) Appl. No.: 12/816,799

(22) Filed: Jun. 16, 2010

Related U.S. Application Data
(63) Continuation of application No. PCT/EP2008/068258, filed on Dec. 23, 2008.

(30) Foreign Application Priority Data
Jan. 18, 2008 (DE) 10 2008 005 199.3

(51) Int. Cl. B08B 9/027

(52) U.S. Cl. 134/22.11

(57) ABSTRACT

A physical-chemical method for cleaning a secondary chamber of a heat exchanger in a nuclear facility, includes drying the secondary chamber and introducing a cleaning solution into the secondary chamber to treat deposits present in the secondary chamber.

### CROSS-REFERENCE TO RELATED APPLICATION

This is a continuation, under 35 U.S.C. §120, of copending International Application No. PCT/EP2008/068258, filed Dec. 23, 2008, which designated the United States; this application also claims the priority, under 35 U.S.C. §119, of German Patent Application DE 10 2008 005 199.3, filed Jan. 18, 2008; the prior applications are herewith incorporated by reference in their entirety.

### BACKGROUND OF THE INVENTION

### Field of the Invention

The invention relates to a method for cleaning a secondary chamber of a heat exchanger, in particular of a steam generator in a nuclear facility. A method of that type, which is disclosed, for example, by European Patent Application EP 0 198 340 A1, corresponding to U.S. Pat. No. 4,720,306, is used to remove deposits which are present on the secondary side in a steam generator and have formed there during operation.

A heat exchanger has a primary space or chamber and a secondary space or chamber, through which a primary coolant and a secondary coolant flow during operation. In the process, the primary coolant heats the secondary coolant flowing through the secondary chamber while transferring some of its heat. The steam generator in a nuclear facility is a special heat exchanger. In a pressurized-water reactor, the primary coolant heated in the reactor core is fed to a steam generator. The steam generator is used to heat or evaporate a secondary coolant which is in turn used to operate a generator for generating electricity.

While heat-exchanger tubes themselves usually are formed of corrosion-resistant alloys, the shell and the support of the heat-exchanger tubes are typically made of C-steel or other low-alloyed steels. When the nuclear power plant is in operation, those parts are subject to corrosion. Corrosion products, primarily magnetite (Fe₃O₄), settle as layers on the surfaces of the secondary chamber of the heat exchanger. Those layers and deposits primarily are formed of magnetite, but also contain copper, nickel, zinc, chromium and other elements and combinations thereof.

The primary or tube side of a heat exchanger, that is to say the inside of the heat-exchanger tubes, can be accessed relatively easily through the primary-side water chamber, and any deposits which may be present therefore can be removed relatively easily. The secondary chamber of a heat exchanger is comparatively more difficult to access and thus also more difficult to clean.

Usually, a tube bundle of heat-exchanger tubes extends into the secondary chamber. In such a tube bundle, the outer sides or cladding sides of the heat-exchanger tubes conceal each other. Any deposits present on the cladding side are therefore difficult to remove. In addition to the tube bundle, further fixtures and supports for fixing the heat-exchanger tubes are located in the secondary chamber. A great many crannies and crevices, which exist between the heat-exchanger tubes and such supports and in which deposits can collect, are difficult to access.

The deposits which are present in the secondary chamber entail various technical difficulties. The deposits which are present on the surface of the heat-exchanger tubes lead to a deterioration of heat transfer between the primary coolant and the secondary coolant. In addition, the deposits bring about various damaging mechanisms. They can accelerate the corrosion of the affected components, for example.

In order to meet those technical challenges, the secondary chamber of the heat exchanger is cleaned and the deposits are removed from it, as much as possible. In steam generators in nuclear facilities, so-called maintenance cleaning can be carried out in addition to a complete cleaning operation. Such a maintenance cleaning involves merely removing some of the layers that are present. Maintenance cleaning aims to remove the layers to such an extent that roughly the same amount as that which has formed there since the last maintenance cleaning is removed from the steam generator. The state of the steam generator can thus be maintained or possibly slightly improved.

Mechanical cleaning methods for removing deposits, such as flushing the tube sheet, only have limited effectiveness or their use is restricted due to poor access to the internal space of the steam generator. For that reason, mainly chemical cleaning methods are used for the removal of deposits and layers.

German Published, Non-Prosecuted Patent Application DE 102 38 730 A1, corresponding to U.S. Patent Application Publication No. US 2005/0126587, discloses a chemical cleaning method of that kind. The steam generator is filled with a cleaning solution containing a complexing agent for dissolving ferrous deposits and is treated at pressures between 6 and 10 bar and at temperatures of above 140° C. In order to mix the cleaning solution, the steam generator is subjected to sudden pressure drops. When the ferrous layers have been dissolved, the cleaning solution is drained from the steam generator. If the deposits also contain copper or copper compounds, they are dissolved subsequently by using an alkaline cleaning solution in the presence of an oxidant and a complexing agent.

Another cleaning method is disclosed in European Patent Application EP 0 198 340 A1, corresponding to U.S. Pat. No. 4,720,306. In contrast with the previously described cleaning method, in that case the copper compounds are dissolved first and then the ferrous layers (magnetite).

Also known are methods in which both magnetite and copper are removed by using one cleaning solution, that is to say without intermediate draining and refilling of the steam generator. The cleaning solution located in the steam generator is changed once the magnetite is dissolved, with the result that copper and copper compounds can subsequently be dissolved. A method of that type is disclosed, for example, in German Published, Non-Prosecuted Patent Application DE 198 57 342 A1.

One disadvantage of the above-mentioned chemical methods is primarily the high consumption of cleaning chemicals.

### SUMMARY OF THE INVENTION

It is accordingly an object of the invention to provide an alternative method for cleaning a heat exchanger, which overcomes the hereinafore-mentioned disadvantages of the heretofore-known methods of this general type and which operates with improved efficiency and accordingly with reduced use of chemicals.

With the foregoing and other objects in view there is provided, in accordance with the invention, a method for cleaning a secondary chamber through which a secondary coolant flows during operation of a heat exchanger in a nuclear facility, by removing deposits formed during operation at and on surfaces of the secondary chamber. The method comprises drying the deposits while the secondary chamber is largely emptied of secondary coolant, and subsequently introducing a cleaning solution into the secondary chamber.

The method according to the invention is based on the following considerations: it has been found that the deposits present in the secondary chamber of the heat exchanger are mechanically destabilized by a drying operation. As a consequence, they flake at least partially off the surfaces of the secondary chamber. The deposits on the cladding side of the heat-exchanger tubes are largely dissolved and drop to the tube sheet. At least some of the deposits present on the surfaces of the secondary chamber can be removed in this manner without the use of chemicals. The deposits which are removed in this manner accumulate on the tube sheet of the heat exchanger. The deposits which are still present on the surfaces are subsequently at least partially removed with the aid of the cleaning solution introduced into the secondary chamber. The method according to the invention is thus a combined physical-chemical cleaning method.

According to the invention, the chemicals used to dissolve the deposits can be dosed more sparingly as compared to conventional cleaning methods for the following reasons. In particular, the cleaning chemicals can be dosed substoichometrically based on the mass of impurities present in the secondary chamber. The deposits accumulated on the tube sheet of the heat exchanger provide a comparatively small surface area for the cleaning solution, based on their mass. The deposits still present on the surfaces of the secondary chamber, on the other hand, have a comparatively large surface area, based on their mass. Even in absolute comparison, the total surface area of the deposits present on the surfaces of the secondary chamber will typically be many times larger than the surface area of the deposits accumulated on the tube sheet. The deposits which are still present on the surfaces of the secondary chamber, in particular on the cladding sides of the heat-exchanger tubes, thus provide a comparatively large area of attack for the cleaning solution. For this reason, the deposits which still remain on the surfaces of the secondary chamber of the heat exchanger are dissolved many times faster than the deposits which cumulate on the tube sheet.

The cleaning solution used to clean the secondary chamber of the heat exchanger does not need to completely dissolve the deposits and impurities present in the secondary chamber and therefore can be dosed substoichiometrically, based on the total mass of the deposits. The cleaning method according to the invention simply involves waiting until the deposits which are still present on the surfaces of the secondary chamber of the heat exchanger are dissolved. The deposits accumulated on the tube sheet are removed from the secondary chamber of the heat exchanger, for example by using a mechanical cleaning method, after the cleaning solution has been drained off. In order to remove deposits located on the tube sheet of the heat exchanger, the tube sheet may be flushed, for example (tube sheet lancing).

Physically drying the deposits also results in cracks therein. These cracks increase the surface area of the deposits and consequently provide a larger area of attack for the cleaning solution. The cracks additionally enable easier access to the interior of the deposits for the cleaning solution. Inclusions or pores which are possibly present inside the deposits become accessible for the cleaning solution through the cracks. The deposits are attacked by the cleaning solution more effectively in contrast with conventional cleaning methods.

The physical drying step which comes before the chemical cleaning and can be carried out, for example, by introducing hot air or inert gas, also has the effect that the water contained in surface pores and channels in the deposits is removed. In conventional methods, pores which are present in the deposits may still be filled with water, with the result that not only is the penetration of cleaning solution severely obstructed but the water which is present also causes local dilution which reduces the cleaning efficiency. By first carrying out a physical drying operation, the cleaning solution can penetrate the pores and channels in the deposits in a practically undiluted state. The cleaning solution is thus utilized more effectively than is possible in conventional methods. In a cost-saving manner, cleaning can therefore be effected faster and with reduced use of cleaning chemicals.

In accordance with another particularly preferred mode of the invention, the drying of the deposits present in the secondary chamber is effected by evacuating the secondary chamber. In order to encourage the evaporation of the water, drying takes place, according to a further embodiment, both by way of reduced pressure and at increased temperatures, for example by using residual heat caused by the operation. It has now surprisingly been found that the cleaning efficiency of a cleaning solution which is filled in after the drying step is particularly high if in the process the reduced pressure prevailing in the secondary chamber is maintained preferably during the entire filling-in phase. One possible explanation for this is that the cleaning solution can penetrate the evacuated cracks and pores more easily under a vacuum than is possible under normal pressure. As a result of the evacuation, the cracks and pores practically no longer contain any gas which would otherwise have to be displaced by the cleaning liquid. The cleaning solution can thus penetrate the pores and cracks more easily.

A further advantageous effect is that some of the cleaning solution evaporates when it is introduced into the still hot secondary chamber to which negative pressure is additionally applied. The gaseous cleaning solution condenses on the layers and precipitates preferably in the pores and cracks (capillary condensation).

As mentioned above, drying of the deposits causes them to become mechanically destabilized and to flake off at least partially from the surface of the secondary chamber. This effect can be increased by bringing the cleaning solution introduced into the secondary chamber to a boil, according to a further embodiment. Even the cleaning solution present in the pores and cracks of the deposits begins to boil. The positive pressure which is thus produced in the pores and cracks, that is to say in the interior of the deposits, results in a mechanical destabilization of the deposits. Heating of the cleaning solution can be effected or encouraged by introducing superheated steam into the secondary chamber. The superheated steam introduced into the cleaning solution not only effects the heating but also the mixing of the cleaning solution. Unused cleaning solution thus reaches those places where there is a greater incidence of deposits, which can now be dissolved.

The deposits which form during operation on the surfaces of the secondary chamber of a heat exchanger or of a steam generator mainly contain iron oxide (magnetite), but in part also metallic copper and copper compounds. Those deposits can be dissolved by using cleaning solutions which are disclosed by German Published, Non-Prosecuted Patent Application DE 102 38 730 A1, corresponding to U.S. Patent Application Publication No. US 2005/0126587; European Patent Application EP 0 198 340 A1, corresponding to U.S. Pat. No. 4,720,306; German Published, Non-Prosecuted Patent Application DE 198 57 342 A1; or European Patent Application EP 0 273 182 A1, corresponding to U.S. Pat. Nos. 5,264,014 and 5,164,015, which are mentioned in the introduction.

The drying step according to the invention is carried out, depending on which combination of chemicals is used for the cleaning solution, at least once, specifically before the cleaning solution is filled into the steam generator. Such a procedure is appropriate when cleaning chemicals according to German Published, Non-Prosecuted Patent Application DE 198 57 342 A1 are used, in which the steam generator is not emptied between the magnetite and the copper removal. In a cleaning method in which the cleaning solution is drained off between the magnetite and the copper removal, as is provided for example in DE 102 38 730 A1, corresponding to U.S. Patent Application Publication No. US 2005/0126587, a further drying step can optionally be performed after the first cleaning solution is drained off. Such an intermediate drying step can, of course, likewise be performed in a method in which first the copper and then the magnetite is removed, as is disclosed, for example, in European Patent Application EP 0 198 340 A1, corresponding to U.S. Pat. No. 4,720,306.

In accordance with a further mode of the invention, the cleaning solutions being used are particularly effective at a temperature of between 40° C. and 160° C. For this reason, according to a development of the method according to the invention, the cleaning solution present in the secondary chamber of the steam generator is heated to a temperature in the above-mentioned range. The dissolved deposits are removed by draining the cleaning solution from the secondary chamber of the heat exchanger. The deposits which have not been dissolved and which have collected mainly at the bottom of the heat exchanger are removed from the heat exchanger by mechanical cleaning, for example by flushing.

In accordance with a concomitant mode of the invention, the heat exchanger is the steam generator in a nuclear facility. In steam generators in nuclear facilities, the deposits are formed predominantly of magnetite. The method according to the invention can be used particularly advantageously to free the steam generator of magnetite-containing layers in the context of so-called maintenance cleaning.

Other features which are considered as characteristic for the invention are set forth in the appended claims.

Although the invention is illustrated and described herein as embodied in a method for cleaning a heat exchanger, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a highly diagrammatic, longitudinal-sectional view of a steam generator in a nuclear facility; and

FIG. 2 is an enlarged, fragmentary, longitudinal-sectional view of such a steam generator.

### DETAILED DESCRIPTION OF THE INVENTION

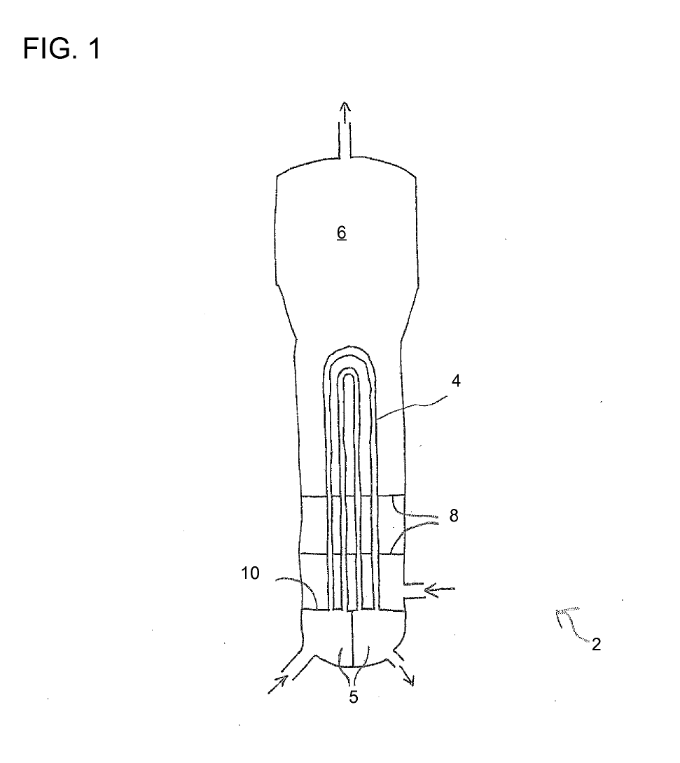

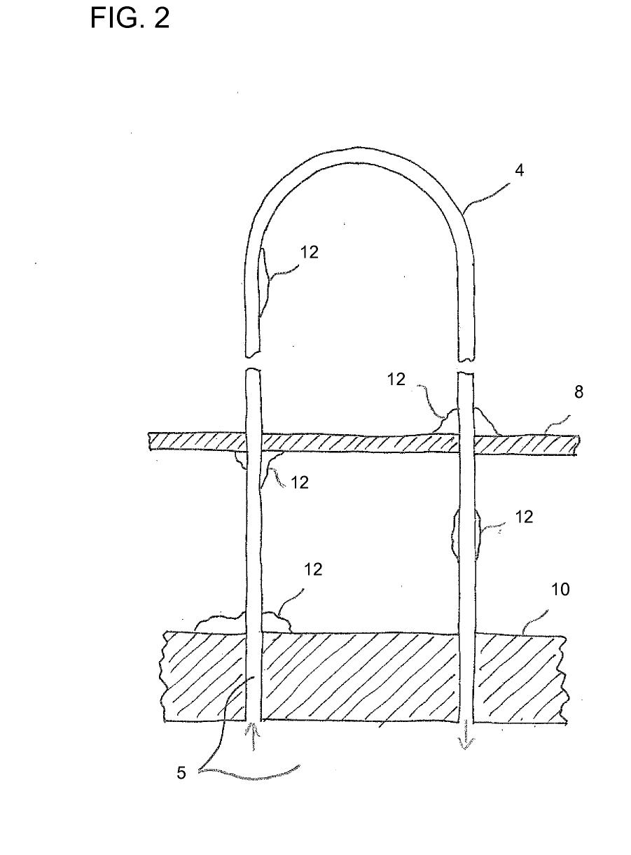

Referring now to the figures of the drawings in detail and first, particularly, to FIG. 1 thereof, there is seen a steam generator 2 having a primary space or chamber 5 through which a primary coolant heated in a reactor core of a pressurized-water reactor flows. A large number of U-shaped tubes 4, which are also referred to as tube bundles, are located in the lower part of the steam generator 2. For reasons of clarity, only two U-tubes 4 are shown. The primary coolant, which enters the primary chamber 5, flows through the U-tubes 4 while transferring some of its heat to a secondary coolant present in a secondary space or chamber 6. The secondary coolant, which is fed to the steam generator 2 in the lower region of the secondary chamber 6 and is then heated or evaporated, is removed from the secondary chamber 6 in the upper region and used for the operation of a generator. During operation of the steam generator 2, deposits 12 form in the secondary chamber 6, as is seen in FIG. 2. These deposits 12 form in the region of supports 8, but mostly, however, on outer sides or cladding sides of the U-tubes 4 themselves.

FIG. 2 shows a section of the steam generator 2 of FIG. 1 in the region of the bent U-tubes 4. A U-tube 4 through which primary coolant flows is shown by way of example, with the U-tube 4 being held by a support 8 and emerging in the primary region 5 by way of passing through a base plate 10. The deposits 12 are present at transitions between the support 8 and the U-tube 4, at transitions between the base plate 10 and the U-tube 4 and also on the cladding side of the U-tubes 4 themselves. In terms of amount, the predominant part of the deposits 12 is located on the surface of the U-tubes 4 themselves.

The profile of a two-stage cleaning of the steam generator 2 will be explained below, wherein the deposits are intended to contain, by way of example, largely iron oxide (magnetite) and to a lesser degree copper:

After the reactor on the primary side of the steam generator 2 is switched off, initially the secondary coolant is drained out of the steam generator 2. Subsequently, the secondary chamber 6 is subjected to negative pressure and/or evacuated. In this case, the magnitude of the negative pressure is chosen in such a way that the negative pressure is at least sufficient, at the given temperature, to evaporate the secondary coolant, typically water. Alternatively, the secondary chamber 6 of the steam generator 2 is dried by introducing hot air. The impurities 12 dry very quickly under the described conditions, wherein their surface develops cracks. As already mentioned, the deposits partially flake off their substrate due to the volume loss occurring during drying. The flaked-off deposits accumulate in the region of the base plate or lower tube sheet 10 of the steam generator 2. The secondary chamber 6 of the steam generator 2 is preferably held under vacuum, while the cleaning solution is introduced into it. In this case, the cleaning solution is filled into the secondary chamber 6 of the steam generator 2, preferably up to the upper edge of the tube bundle.

The cleaning solution used to dissolve the magnetite layers contains a complexing acid, for example ethylendiamintetraacetic acid (EDTA), an alkalizing agent, such as ammonia, morpholine or a mixture of those substances and a reducing agent, for example hydrazine. Other, generally known cleaning solutions, can likewise be used to remove the magnetite-containing layers.

In order to improve the cleaning efficiency, the cleaning solution is heated to a temperature in the range of 40° C. to 160° C. This is preferably effected by introducing superheated steam into the steam generator. Alternatively, the cleaning solution is heated with the aid of main coolant pumps through the primary circuit of the nuclear facility. If the cleaning solution is heated to boiling, this leads to a mixing of the cleaning solution. Alternatively, inert gas is pressed into the steam generator for mixing the cleaning solution. Used and unused cleaning solution are mixed, wherein in particular unused cleaning solution reaches places where deposits 12 are still present, with the result that they can be dissolved in this manner. The deposits 12 are additionally mechanically removed from the surfaces of the steam generator by the boiling cleaning solution.

The magnetite deposits, which are dissolved by the cleaning solution, are removed from the secondary chamber or area 6 by draining off the cleaning solution. The remaining magnetite deposits, which are not dissolved by the cleaning solution and which accumulate on the tube sheet 10, are removed from the secondary chamber 6 mechanically, for example by flushing the tube sheet 10.

Before the copper-containing deposits 12 are subsequently removed from the steam generator 2, the latter is dried again. This additional drying step once again leads to a physical/mechanical destabilization of the deposits 12 which remain after the first cleaning step.

The copper-containing deposits 12 are dissolved by water-soluble complexes of the copper compounds being formed. Suitable complexing agents are, for example, ethylenediamine (EDA), ethylenediaminetetraacetic acid (EDTA) in ammoniacal solution under oxidizing conditions. Oxidizing conditions are achieved, for example, by dosing in hydrogen peroxide and/or blowing in air or oxygen. Once the copper-containing deposits 12 are dissolved, the cleaning solution is drained out of the steam generator 2.

1. A method for cleaning a secondary chamber through which a secondary coolant flows during operation of a heat exchanger in a nuclear facility, by removing deposits formed during operation at and on surfaces of the secondary chamber, the method comprising the following steps:
drying the deposits while the secondary chamber is largely emptied of secondary coolant; and
introducing a cleaning solution into the secondary chamber.

2. The method according to claim 1, which further comprises applying negative pressure to the secondary chamber for drying the deposits.

3. The method according to claim 2, which further comprises carrying out the step of introducing the cleaning solution into the secondary chamber when the negative pressure is applied to the secondary chamber.

4. The method according to claim 1, which further comprises heating the cleaning solution to a temperature of between 40° C. and 160° C.

5. The method according to claim 4, which further comprises carrying out the step of heating the cleaning solution by introducing superheated steam into the secondary chamber.

6. The method according to claim 1, which further comprises bringing the cleaning solution in the secondary chamber to a boil.

7. The method according to claim 1, which further comprises removing the deposits present in the secondary chamber from the secondary chamber at least partially by flushing.

8. The method according to claim 1, which further comprises cleaning deposits largely containing magnetite off the secondary chamber of the heat exchanger.

9. The method according to claim 1, wherein the heat exchanger being cleaned is a steam generator in the nuclear facility.
